(19) United States
(12) Patent Application Publication
(10) Pub. No.: US 2018/0046326 A1
(43) Pub. Date: Feb. 15, 2018

(54) OPTICAL FILM AND USER INPUT SYSTEM

(71) Applicants: CHI HSIANG OPTICS CO., LTD., Zhubei City (TW); NEOLAB CONVERGENCE TAIWAN INC., Taipei City (TW)

(72) Inventors: Po-Hung YAO, Zhubei City (TW); Feng-Chih CHEN, Taipei City (TW); Hsien-Ching CHANG, Taipei City (TW)

(21) Appl. No.: 15/665,814

(22) Filed: Aug. 1, 2017

(30) Foreign Application Priority Data
Aug. 12, 2016 (TW) 105125795

(51) Int. Cl. G06F 3/042; G02B 17/00; G02B 5/02

(52) U.S. Cl. CPC G06F 3/0421; G02B 5/0242; G02B 5/021; G02B 17/00

(57) ABSTRACT

An optical film includes a substrate and a reflecting layer. The substrate has a sensing surface and an opposite back surface. The reflecting layer is disposed on the sensing surface of the substrate to reflect a sensing light and includes a coding pattern, wherein the coding pattern is formed by damaging a structure of the reflecting layer, and the coding pattern includes a coding information. The above-mentioned coding pattern of the optical film is a depressed structure, which can reduce the wear caused by the repeated writing of an optical reading device. A user input system including the above-mentioned optical film is disclosed as well.

### BACKGROUND OF THE INVENTION

### 1. Field of the Invention

The present invention relates to an optical film and a user input system, and more particularly to an optical film and a user input system that a user can input with an optical reading device.

### 2. Description of the Prior Art

A user input system disposes the coding pattern including the addressing information on the substrate, and a user may use an appropriate reading device to decode the addressing information in the coding pattern, so as to record the moving trace of the reading device on the substrate surface. In general, the reading device has a pen structure, so that the user may interact with an electronic device with the used writing manner. The coding pattern of prior-art is mostly disposed on the substrate surface convexly, and therefore, the repeated writing of the reading device may easily cause the coding pattern damaged.

Thus, the most important goal for now is to provide a coding pattern that has a better durability.

### SUMMARY OF THE INVENTION

The present invention is directed to provide an optical film and a user input system, which remove partial reflecting layer to form a coding pattern. Therefore, the coding pattern may not be easily damaged by the repeated writing of the optical reading device, so as to improve the durability of the optical film.

An optical film of one embodiment of the present invention includes a substrate and a reflecting layer. The substrate has a sensing surface and an opposite back surface. The reflecting layer is disposed on the sensing surface or the back surface of the substrate to reflect a sensing light and includes a coding pattern, wherein the coding pattern is formed by damaging a structure of the reflecting layer, and the coding pattern includes a coding information.

A user input system of another embodiment of the present invention includes an optical film and an optical reading device. The optical film includes a substrate and a reflecting layer. The substrate has a sensing surface and an opposite back surface. The reflecting layer is disposed on the sensing surface or the back surface of the substrate to reflect a sensing light and includes a coding pattern, wherein the coding pattern is formed by damaging a structure of the reflecting layer, and the coding pattern includes a coding information. The optical reading device has a contact end to abut against a side of the sensing surface of the optical film. The optical reading device includes a light emitting unit, an image sensor, a processing unit and a communication interface. The light emitting unit is used to produce the sensing light to irradiate the optical film. The image sensor is used to sense the sensing light reflected by the coding pattern and output a sensing image. The processing unit is electrically connected to the image sensor to analyze the sensing image to obtain the coding information of the coding pattern. The communication interface is electrically connected to the processing unit to transmit the coding information to an external electronic device.

The objective, technologies, features and advantages of the present invention will become apparent from the following description in conjunction with the accompanying drawings wherein certain embodiments of the present invention are set forth by way of illustration and example.

### BRIEF DESCRIPTION OF THE DRAWINGS

FIG. 1 is a schematic view, showing an optical film of one embodiment of the present invention.

FIG. 2 is a schematic view, showing an optical film of another embodiment of the present invention.

FIG. 3 is a schematic view, showing a user input system of one embodiment of the present invention.

FIG. 4 is a schematic view, showing an optical reading device of the user input system of one embodiment of the present invention.

FIG. 5 is a schematic view, showing the configuration of a coding pattern.

FIG. 6 is a schematic view, showing the configuration of another coding pattern.

### DESCRIPTION OF THE PREFERRED EMBODIMENT

Various embodiments of the present invention will be described in detail below and illustrated in conjunction with the accompanying drawings. In addition to these detailed descriptions, the present invention can be widely implemented in other embodiments, and apparent alternations, modifications and equivalent changes of any mentioned embodiments are all included within the scope of the present invention and based on the scope of the Claims. In the descriptions of the specification, in order to make readers have a more complete understanding about the present invention, many specific details are provided; however, the present invention may be implemented without parts of or all the specific details. In addition, the well-known steps or elements are not described in detail, in order to avoid unnecessary limitations to the present invention. Same or similar elements in Figures will be indicated by same or similar reference numbers. It is noted that the Figures are schematic and may not represent the actual size or number of the elements. For clearness of the Figures, some details may not be fully depicted.

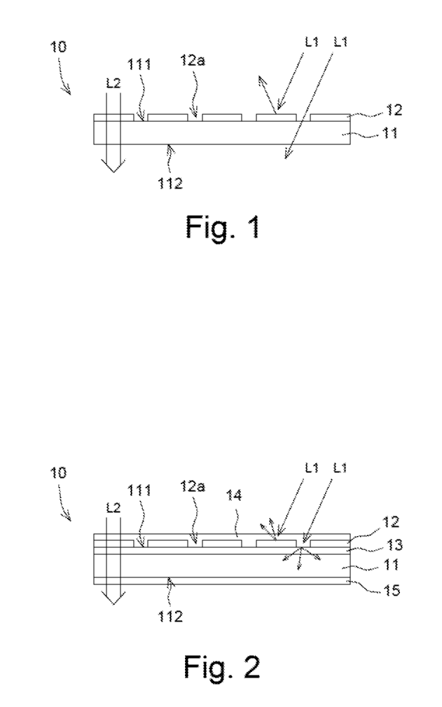

Referring to FIG. 1, an optical film 10 of one embodiment of the present invention includes a substrate 11 and a reflecting layer 12. The substrate 10 has a sensing surface 111 and an opposite back surface 112. In one embodiment, a material of the substrate 11 may be polyethylene terephthalate (PET), Polycarbonate (PC), Polymethylmethacrylate (PMMA), Polyimide (PI), cellulose triacetate (TAC), cyclic olefin polymer (COP) or a PC-PMMA composite film.

The reflecting layer 12 is disposed on the sensing surface 111 of the substrate 11 to reflect a sensing light L1, which is not a limitation, and the reflecting layer 12 may be disposed on the back surface 112 of the substrate 11 as well. In one embodiment, the sensing light L1 may be the invisible light, such as the infrared or ultraviolet light. The reflecting layer 12 includes a coding pattern 12a. For example, the coding pattern 12a may be multiple pattern units, and each pattern unit may be a line, a circle, an ellipse, a polygon or a combination thereof. Preferably, a length of a long axis of each pattern unit is different from that of a short axis of each pattern unit, such that the azimuth difference of the pattern units may be determined, such as the rotation angle. It may be understood that the coding pattern 12a includes a coding information. For example, the coding information may be at least one of the addressing information, text information, image information, control instruction and anti-counterfeiting information.

In one embodiment, the coding pattern 12a is formed by damaging a structure of the reflecting layer 12. For example, the reflecting layer 12 may be formed by using the coating or blooming technology to totally cover the sensing surface 111 of the substrate 11 with a film material structure that may produce reflection for the sensing light of a particular wavelength. Then, the required coding pattern 12a may be formed by using the dry etching, wet etching, or laser engraving technology to remove the reflecting layer 12 according to a particular pattern. In one embodiment, the reflecting layer 12 may be a diffractive optical structure, a structure of multiple layers of films having different refractive indexes or a liquid crystal material. It may be understood that the reflecting layer 12 corresponding to the position of the coding pattern may not be necessary to be completely removed. For example, the reflecting layer 12 may be a structure of multiple layers of films having different refractive indexes. The reflecting optical property of the reflecting layer 12 may be damaged by using the etching process or laser engraving process to remove a specific number of the layers of the films. In one embodiment, the substrate 11 and the reflecting layer 12 allow the visible light L2 to transmit, so that the optical film 10 of the present invention may be applied to a display device, i.e., the image of the visible light displayed by the display device may transmit through the optical film 10 of the present invention.

According to the above structure, the pressure that the optical reading device applies to the optical film 10 of the present invention is mostly fallen on the reflecting layer 12 of a continuous structure, and therefore, the depressed coding pattern 12a may not be easily worn by the repeated writing of the optical reading device.

Referring to FIG. 2, the optical film 10 of one embodiment of the present invention further includes a scattering layer 13 that is disposed between the substrate 11 and the reflecting layer 12. The scattering layer 13 may let the reflecting layer 12 to diffusively reflect the sensing light L1, i.e., softening or homogenizing the reflecting intensity of the sensing light L1. In one embodiment, the scattering layer 13 may comprise a polymer and a plurality of scattering particles dispersed in the polymer. It may be understood that the refractive index of the scattering particles is different from the refractive index of the polymer. Or, the scattering layer 13 may be the roughed sensing surface 111 or the roughed back surface 112 of the substrate 11. In one embodiment, a surface roughness of the scattering layer 13 is more than 25 nm.

Referring to FIG. 2 again, in one embodiment, the optical film 10 further includes a coating layer 14 that covers the reflecting layer 12 and is filled in the coding pattern 12a. It may be understood that the coding pattern 12a filled with the coating layer 14 may further avoid the wear of the coding pattern 12a. In one embodiment, the refractive index of the coating layer 14 may be the same as or different from the refractive index of the substrate 11. Preferably, the coating layer 14 has at least one property of hard coating, anti-glare, anti-reflection, anti-fingerprint, hydrophobic, and anti-static.

In one embodiment, the optical film 10 of the present invention further includes an adhesive layer 15 that is disposed on the back surface 112 of the substrate 11. Thus, the optical film 10 of the present invention may be attached to an appropriate operating surface, such as the display surface of the display device or a whiteboard. In one embodiment, the adhesive layer 15 has a high transmittance, and for example, the transmittance of the adhesive layer 15 is more than 70%. In one embodiment, the adhesive layer 15 may include a light absorption material that may absorb the light of a particular wavelength, such as the dye or other light absorption agent, so as to meet the requirement of the practical application. For example, the blue dye may be added to change the basic color of the film material.

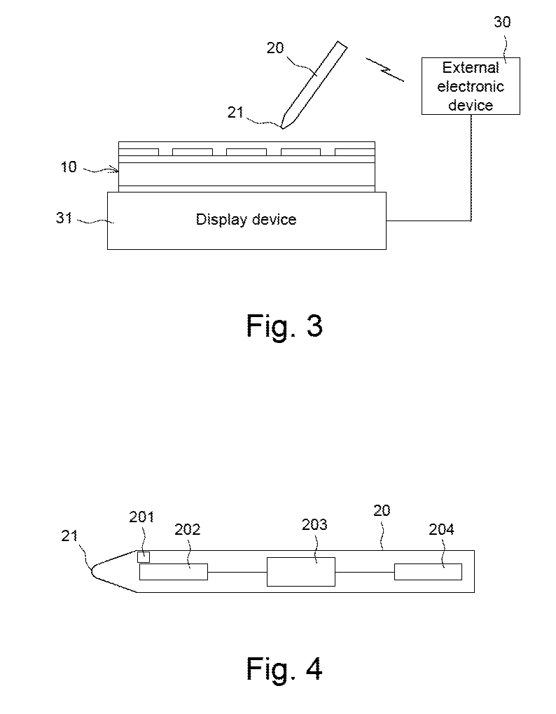

Referring to FIG. 3 and FIG. 4, a user input system of one embodiment of the present invention includes an optical film 10 and an optical reading device 20. The detailed structure of the optical film 10 is as described above, and omitted here. The optical reading device 20 has a contact end 21 that is used to abut against a side of the sensing surface 111 of the optical film 10, such that a user may interact with an electronic device with the used writing actions. The optical reading device 20 includes a light emitting unit 201, an image sensor 202, a processing unit 203 and a communication interface 204.

The light emitting unit 201 is used to produce the sensing light L1 to irradiate the optical film 10. For example, the light emitting unit 201 may be a light-emitting diode that emits the infrared or ultraviolet light, and preferably, the light emitting unit 201 is a light-emitting diode that emits the infrared light. The image sensor 202 is used to sense the sensing light L1 from the coding pattern and output a sensing image. For example, the image sensor 202 includes a lens and a Charge Coupled Device (CCD) or a Complementary Metal Oxide Semiconductor (CMOS) sensor. The lens may be made of poly methyl methacrylate (PMMA), and may be an optical element that is usually injection-molded. The PMMA has a property of anti-scratch, and has a transmittance of about 90% for the light of the wavelength of 810 nm. A size of the CCD or CMOS sensor may be 128×128 pixels, and preferably, the size of the CCD or CMOS sensor may be 140×140 pixels, so as to have a better manufacturing tolerance.

The processing unit 203 is electrically connected to the image sensor 202. The processing unit 203 may analyze the sensing image to obtain the coding information contained in the coding pattern, such as the addressing information, text information, image information, control instruction or anti-counterfeiting information, etc. The communication interface 204 is electrically connected to the processing unit 203. The communication interface 204 may transmit the coding information, such as the addressing information, text information, image information, control instruction or anti-counterfeiting information, etc., that is obtained by the processing unit 203 to an external electronic device 30. For example, the communication interface 204 may be a wire communication interface or a wireless communication interface. Preferably, the communication interface 204 may be a wireless communication interface, so that a disturbance of the wire may be avoided when the user is at the writing operation. For example, the wireless communication interface may be the Bluetooth, wireless local area network (WLAN), ZigBee communication, wireless USB or mobile communication network.

In one embodiment, the user input system of the present invention further includes a display device 31 that is disposed at a side of the back surface of the optical film 10, i.e., the optical film 10 is disposed on a display surface of the display device 31. The display device 31 is electrically connected to the external electronic device 30. Based on this architecture, the external electronic device 30 may present the coding information received from the optical reading device 20 through the display device 31 in real-time. For example, the user may sign or paint on the optical film 10 of the present invention with the optical reading device 20, and the external electronic device 30 may display the sign or paint of the user through the display device 31 in real-time. Or, the user may click on a specific area of the optical film 10 with the optical reading device 20 to decode the corresponding control instruction, so as to execute the operation, such as clicking, circle-selecting, paging down or scrolling the page, etc.

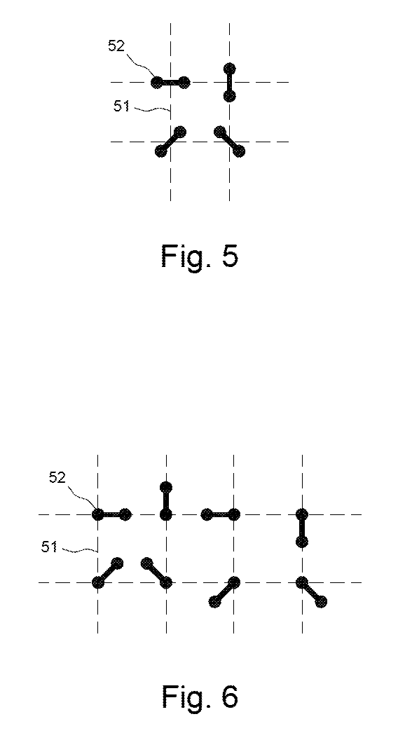

Referring to FIG. 5, in one embodiment, the coding pattern includes virtual grid lines 51 and multiple pattern units 52. The virtual grid lines 51 are not really disposed on the optical film 10, and therefore, are depicted in dotted lines. In one embodiment, the virtual grid lines 51 are perpendicularly intersected with each other, and multiple intersections are formed. The coding information, such as the addressing information, text information, image information, control instruction or anti-counterfeiting information, etc., is encoded according to the positions of the pattern units 52 relative to the intersections of the virtual grid lines 51. In the embodiment shown in FIG. 5, the pattern unit 52 comprises a line segment and circles, and the pattern unit 52 is disposed at the intersection of the virtual grid lines 51 with the center thereof. As shown in FIG. 5, the pattern units 52 that are horizontal, vertical, tilted 45 degrees to the right and tilted 45 degrees to the left respectively may represent four different coding values respectively. Thus, the coding information may be encoded with the pattern units 52. It may be understood that multiple pattern units 52 may form a set to encode more coding information.

Referring to FIG. 6, in one embodiment, the pattern unit 52 may be disposed at the intersection of the virtual grid lines 51 with one endpoint thereof as well. As shown in FIG. 6, the presented pattern units 52 of 0 degrees, 45 degrees, 90 degrees, 135 degrees, 180 degrees, 225 degrees, 270 degrees and 315 degrees may represent eight different coding values respectively. The detailed encoding method is familiar to those skilled in the art and is not the main subject matter of the present invention, and therefore, the descriptions thereof are omitted here. It should be noted that in addition to the above encoding method, the coding information may be implemented with other appropriate encoding method as well.

To sum up the foregoing descriptions, the optical film and the user input system of the present invention remove partial reflecting layer to form the coding pattern having a depressed structure. Therefore, the coding pattern of the optical film of the present invention may not be easily damaged by the repeated writing of the optical reading device, so as to improve the durability of the optical film. Also, a purpose of a reflecting signal having a high contrast may be achieved, and the reading sensitivity of the user input system may be improved significantly.

What is claimed is:

1. An optical film comprising:
a substrate having a sensing surface and an opposite back surface; and
a reflecting layer disposed on the sensing surface or the back surface of the substrate to reflect a sensing light and comprising a coding pattern, wherein the coding pattern is formed by damaging a structure of the reflecting layer, and the coding pattern comprises a coding information.

2. The optical film according to claim 1, wherein the reflecting layer comprises a diffractive optical structure, a structure of multiple layers of films having different refractive indexes or a liquid crystal material.

3. The optical film according to claim 1, further comprising
a scattering layer disposed between the substrate and the reflecting layer, such that the reflecting layer diffusively reflects the sensing light.

4. The optical film according to claim 3, wherein the scattering layer comprises a polymer and a plurality of scattering particles dispersed in the polymer, and the refractive index of the scattering particles is different from the refractive index of the polymer.

5. The optical film according to claim 3, wherein the scattering layer is the roughed sensing surface or the roughed back surface of the substrate.

6. The optical film according to claim 5, wherein a surface roughness of the scattering layer is more than 25 nm.

7. The optical film according to claim 1, further comprising
a coating layer covering the reflecting layer and filled in the coding pattern.

8. The optical film according to claim 7, wherein the coating layer has at least one property of hard coating, anti-glare, anti-reflection, anti-fingerprint, hydrophobic, and anti-static.

9. The optical film according to claim 1, further comprising
an adhesive layer disposed on the back surface of the substrate, wherein a transmittance of the adhesive layer is more than 70%, or the adhesive layer comprises a light absorption material that absorbs light of a particular wavelength.

10. The optical film according to claim 1, wherein the substrate and the reflecting layer allow the visible light to transmit, and the sensing light is invisible light.

11. A user input system comprising:
an optical film comprising:
a substrate having a sensing surface and an opposite back surface; and
a reflecting layer disposed on the sensing surface or the back surface of the substrate to reflect a sensing light and comprising a coding pattern, wherein the coding pattern is formed by damaging a structure of the reflecting layer, and the coding pattern comprises a coding information; and
an optical reading device having a contact end to abut against a side of the sensing surface of the optical film and comprising:
a light emitting unit to produce the sensing light to irradiate the optical film;
an image sensor to sense the sensing light reflected by the coding pattern and output a sensing image;
a processing unit electrically connected to the image sensor to analyze the sensing image to obtain the coding information of the coding pattern; and
a communication interface electrically connected to the processing unit to transmit the coding information to an external electronic device.

12. The user input system according to claim 11, wherein the reflecting layer comprises a diffractive optical structure, a structure of multiple layers of films having different refractive indexes or a liquid crystal material.

13. The user input system according to claim 11, wherein the optical film further comprises:
a scattering layer disposed between the substrate and the reflecting layer, such that the reflecting layer diffusively reflects the sensing light.

14. The user input system according to claim 13, wherein the scattering layer comprises a polymer and a plurality of scattering particles dispersed in the polymer, and the refractive index of the scattering particles is different from the refractive index of the polymer.

15. The user input system according to claim 13, wherein the scattering layer is the roughed sensing surface or the roughed back surface of the substrate.

16. The user input system according to claim 15, wherein a surface roughness of the scattering layer is more than 25 nm.

17. The user input system according to claim 11, wherein the optical film further comprises:
a coating layer covering the reflecting layer and filled in the coding pattern, wherein the refractive index of the coating layer is the same as or different from the refractive index of the substrate.

18. The user input system according to claim 11, further comprising:
an adhesive layer disposed on the back surface of the substrate, wherein a transmittance of the adhesive layer is more than 70%, or the adhesive layer comprises a light absorption material that absorbs light of a particular wavelength.

19. The user input system according to claim 11, wherein the substrate and the reflecting layer allow the visible light to transmit, and the sensing light is invisible light.

20. The user input system according to claim 11, further comprising:
a display device disposed at a side of the back surface of the optical film and electrically connected to the external electronic device.
